(19) United States
(12) Patent Application Publication
(10) Pub. No.: US 2008/0162807 A1
(43) Pub. Date: Jul. 3, 2008

(54) METHOD AND APPARATUS FOR REDUNDANT MEMORY ARRAYS

(76) Inventors: Michael A. Rothman, Puyallup, WA (US); Vincent J. Zimmer, Federal Way, WA (US)

Correspondence Address: INTEL/BLAKELY, 1279 OAKMEAD PARKWAY, SUNNYVALE, CA, 94085-4040, US

(21) Appl. No.: 11/618,579

(22) Filed: Dec. 29, 2006

(51) Int. Cl. G06F 12/06

(52) U.S. Cl. 711/114; 711/105

(57) ABSTRACT

Methods and apparatus for reducing memory access latencies in mirrored memory partitions (sometimes known as a RAID memory) are disclosed. A memory access request is received for a memory address. The memory partition mirrors may reside on different dual in-line memory modules (DIMMs), or alternatively they may reside on a single DIMM. A memory bank associated with the address in each memory partition may be active or not. If one of these memory banks in some memory partition is active, then the memory access request may be serviced using that memory partition in order to avoid delays associated with activation of the other partitions. When none of these memory banks is active (or all of the partitions must be accessed, for example, in a write request) then activation is initiated in order to service the memory access request.

### FIELD OF THE DISCLOSURE

This disclosure relates generally to the field of computer memory systems. In particular, the disclosure relates to techniques to use redundant arrays of memories that increase fault tolerance and decrease access latencies.

### BACKGROUND OF THE DISCLOSURE

In computer systems when there is a need for increased data integrity, such as in a server, or in computer systems dedicated to storage-intensive tasks such as editing of video or audio, redundant hard drives have been used to share or replicate data. A redundant storage system as described is sometimes known as a Redundant Array of Independent (or Inexpensive) Disks (a RAID).

For some memory-intensive and mission-critical computer systems, similar techniques have been applied to main memory storage systems. These systems may use mirrored memories, or what may sometimes be referred to as RAID memory to increase availability and fault tolerance. In the context of memory systems, the acronym RAID has been described by some to mean a Redundant Array of Industry-standard DIMMs.

DIMM stands for a Dual In-line Memory Module, typically having a 64-bit data path for access via an internal 64-bit memory bus. A DIMM comprises a series of random access memory (RAM) integrated circuits (ICs) mounted on a printed circuit board. One type of DIMM, known as a fully buffered DIMM (FB-DIMM) also has a device called an Advanced Memory Buffer (AMB). FB-DIMMs can be connected via high speed serial interfaces to a Memory Controller Hub (MCH). The AMB communicates with the MCH via the high speed serial interfaces and with RAM ICs on the DIMM via the internal memory bus. The AMB reads from and writes to the RAM as instructed by the MCH and can also be used to configure the FB-DIMM.

When DIMMs are used in RAID memory to mirror each other, split transactions are performed—reading or writing to multiple DIMMs for each transaction so as to replicate data and to increase fault tolerance. One drawback to such a scheme is that a particular bank of memory on one of the DIMMs may be in a refresh state or an inactive state, while a corresponding bank in another DIMM is in an active state. In such a case, the split transaction may be significantly delayed by orders of magnitude due to the time required to activate the inactive memory bank. Another drawback is that a mirroring failure may require disabling of an entire DIMM, which can have a capacity for storing gigabytes of data and a cost in thousands of dollars.

It would be desirable to utilize programmable features of an MCH and/or an AMB to alleviate such drawbacks and to improve performance in the RAID memory. To date, the advantages of such programmable features of the MCH and/or the AMB have not been fully utilized.

### DESCRIPTION OF THE DRAWINGS

The present invention is illustrated by way of example and not limitation in the figures of the accompanying drawings.

FIG. 1 illustrates one embodiment of a system for accessing redundant memory arrays and reducing access latencies.

FIG. 2 illustrates a flow diagram for one embodiment of a process to access redundant memory arrays and reduce access latencies.

FIG. 3 illustrates one alternative embodiment of a system for accessing a redundant memory array and reducing access latencies.

FIG. 4 illustrates another alternative embodiment of a system for accessing a redundant memory array and reducing access latencies.

### DETAILED DESCRIPTION

Disclosed herein are processes and apparatus for reducing memory access latencies in mirrored memory partitions (sometimes known as a RAID memory) are disclosed. A memory access request is received for a memory address. The memory partition mirrors may reside on different dual in-line memory modules (DIMMs), or alternatively they may reside on a single DIMM. A memory bank associated with the address in each memory partition may be active or not. If one of these memory banks in some memory partition is active, then the memory access request may be serviced using that memory partition in order to avoid delays associated with activation of the other partitions. When none of these memory banks is active (or all of the partitions must be accessed, for example, in a write request) then activation is initiated in order to service the memory access request.

By employing embodiments of the disclosed processes and apparatus through programmable features of an advanced memory buffer (AMB) and/or of a memory controller hub MCH, reductions in costs, improved fault tolerance and improved access latencies may be realized for memory access requests to a redundant memory array.

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured only in terms of the claims and their equivalents.

Some embodiments of the disclosed processes and apparatus may use an Intel® Active Management Technology (AMT) device to access programmable features of an AMB and/or of an MCH through the System Management Bus (SMBus). Alternative embodiments of the disclosed processes and apparatus may use platform firmware to access programmable features of an AMB and/or of an MCH through abstract Peripheral Component Interconnect (PCI) or chipset registers. In the following discussion, some known structures, circuits, architecture-specific features and the like have not been shown in detail to avoid unnecessarily obscuring the present invention.

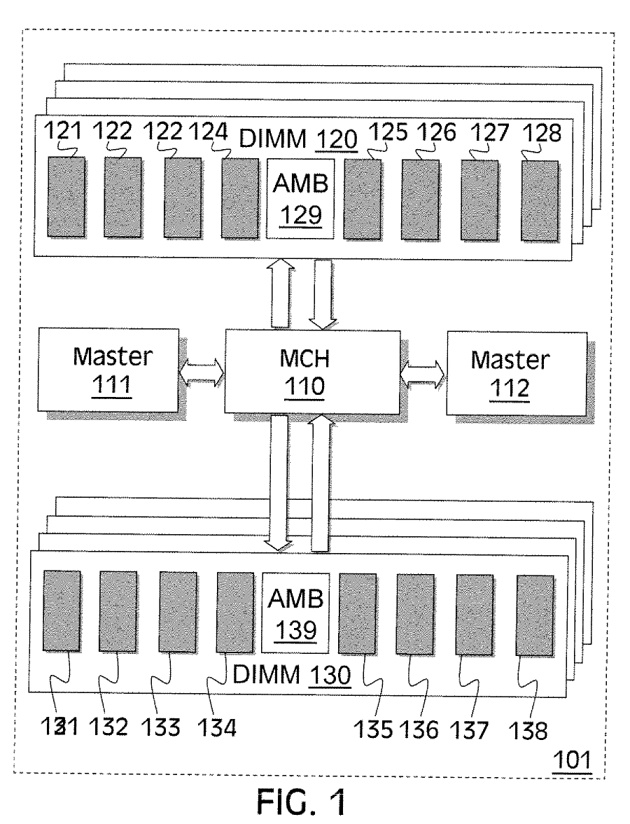

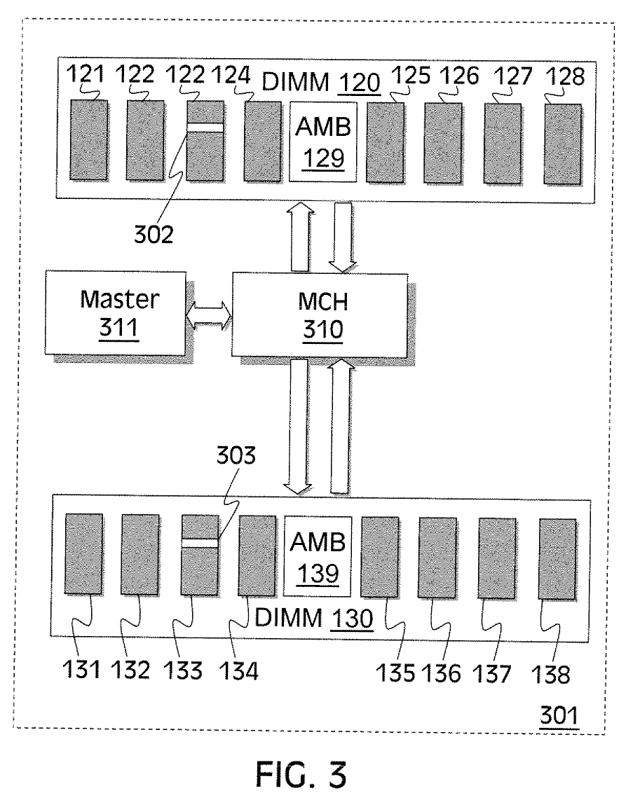

FIG. 1 illustrates one embodiment of a system 101 for accessing redundant memory arrays and reducing access latencies. System 101 includes memory controller hub, MCH 110 and bus masters 111 and 112. A memory access request for a memory address from bus master 111 and/or from bus master 112 is received by MCH 110. For some embodiments, a determination may be made in MCH 110 if any bank (or row) of memory having the requested address is active in one of the mirrored memory DIMMs 120 through 130. One embodiment of MCH 110 is operatively coupled with DIMMs 120 through 130 to transmit memory access requests as split transactions to the redundant mirrored memory DIMMs, or alternatively to transmit a memory access request only to a DIMM having an active memory bank (or row) to avoid an activation delay. Further details of such embodiments are provided below with regard to FIG. 3.

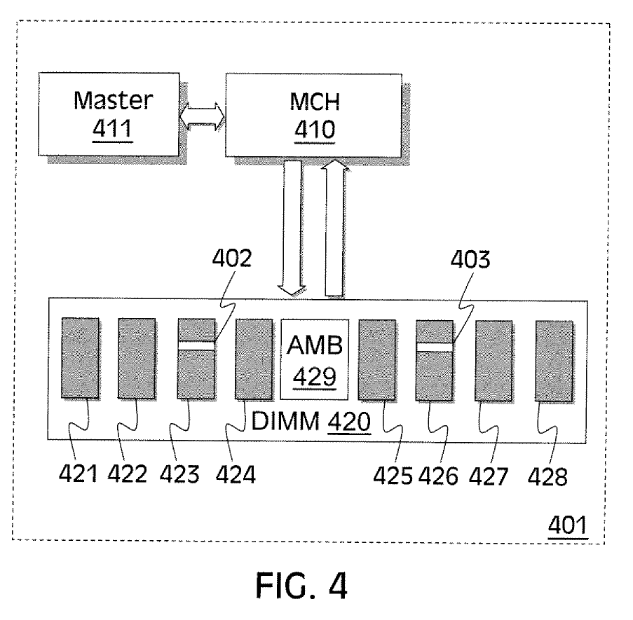

Some embodiments of mirrored memory DIMM 120 are fully buffered DIMMs (FB-DIMMs) including an advanced memory buffer AMB 129 and random access memory (RAM) integrated circuits (ICs) 121-128. Similarly, some embodiments of mirrored memory DIMM 130 are FB-DIMMs including AMB 139 and RAM ICs 131-138. For some alternative embodiments, the determination may be made in AMB 129 and/or in AMB 139 if any bank (or row) of memory having the requested address is active. Embodiments of AMB 129 and AMB 139 may also be operatively coupled with RAM ICs 121-128 and with RAM ICs 131-138, respectively, to transmit memory access requests as split transactions to redundant mirrored RAM ICs within DIMM 120 or within DIMM 130. Alternatively AMB 129 and AMB 139 may be operatively coupled with RAM ICs 121-128 and with RAM ICs 131-138, respectively, to transmit a memory access request only to redundant mirrored RAM IC memory partitions within DIMM 120 or within DIMM 130 having an active memory bank (or row) to avoid an activation delay. Further details of such embodiments are provided below with regard to FIG. 4.

It will be appreciated that the split transaction may be significantly delayed by orders of magnitude due to the time required to activate an inactive memory bank (or row). Thus through programmable features of MCH 110 and/or of AMB 129 and AMB 139, significant improvements in access latencies may be realized for memory access requests to the redundant memory array of system 101.

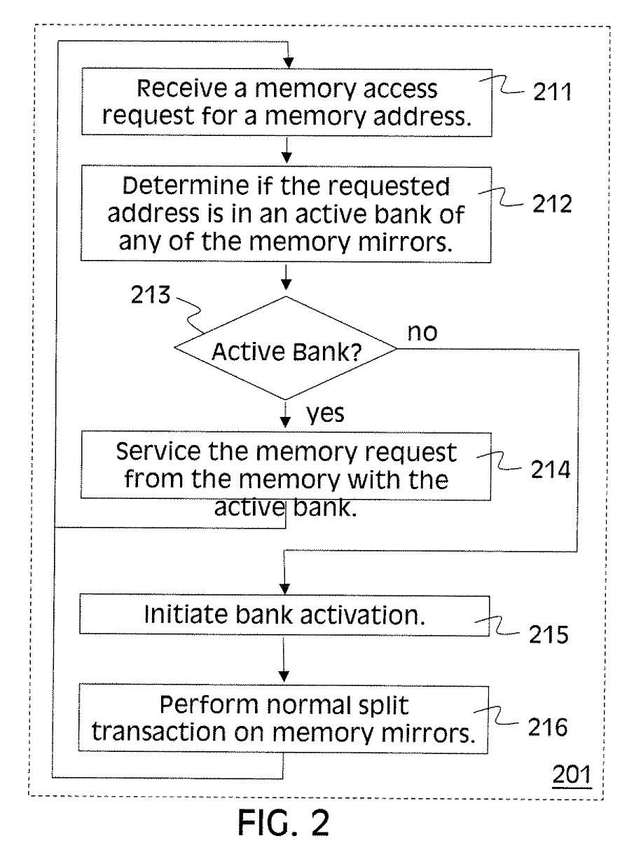

FIG. 2 illustrates a flow diagram for one embodiment of a process 201 to access redundant memory arrays and reduce access latencies. Process 201 and other processes herein disclosed are performed by processing blocks that may comprise dedicated hardware or software or firmware operation codes executable by general purpose machines or by special purpose machines or by a combination of both.

In processing block 211 a memory access request for a memory address is received, for example, by MCH 110 of system 101. In processing block 212 a determination is made if any bank (or row) of memory having the requested address is active in one of the memory mirrors. For some embodiments, the determination may be made in MCH 110 or alternatively in AMB 129 and/or in AMB 139. In processing block 213, if an applicable memory bank (or row) is active, then processing is directed to proceed in processing block 214 where the memory access request is serviced using the active memory bank (or row) to avoid an activation delay. For some embodiments, when the type of request dictates that all of the memory mirrors must be accessed (for example, in a write request) processing is directed as if no active bank (or row) was found and activation of the memory bank (or row) is initiated in processing block 215 to service the memory access request. Then the normal split transaction may be performed in processing block 216 to access all of the memory mirrors.

It will be appreciated that especially in memory hierarchies that include cache memories the vast majority of main memory requests are read requests. In current DIMMs, an active-to-read delay may be on the order of ten to twenty nanoseconds, whereas a refresh-to-active delay may add hundreds to tens of thousands of nanoseconds to that delay—increasing the latency by as much as 10-fold to 5000-fold. Thus a significant improvement in access latencies may be realized for memory access requests to redundant memory arrays.

FIG. 3 illustrates one alternative embodiment of a system 301 for accessing a redundant memory array and reducing access latencies. System 301 includes memory controller hub, MCH 310 and bus master 311.

System 301 includes mirrored memory or RAID memory comprising DIMM 120 and DIMM 130 where mirroring is done between separate DIMMs. DIMM 120 includes AMB 129 and RAM ICs 121-128. Similarly, DIMM 130 includes AMB 139 and RAM ICs 131-138.

A memory access request for a memory address corresponding to the mirrored memory locations 302 and 303 is received by MCH 110 from bus master 111. A determination may be made in MCH 110 if one of the banks (or rows) of memory having the memory locations 302 or the memory locations 303 is active in the mirrored memory DIMM 120 or DIMM 130, respectively. MCH 110 is operatively coupled with DIMM 120 and with DIMM 130 to transmit the memory access request as a split transaction to both DIMM 120 and DIMM 130, or alternatively to transmit the memory access request only to a DIMM having the memory location 302 or the memory location 303 in an active memory bank (or row) to avoid an activation delay.

It will be appreciated that since the split transaction may be significantly delayed due to the time required to activate an inactive memory bank (or row), significant improvements in access latencies may be realized for memory access requests to the redundant memory array of system 301 through utilizing programmable features of MCH 310. It will also be appreciated that a mirroring failure may still require disabling of an entire DIMM, which could mean loss of a capacity for storing gigabytes of data and/or costs in thousands of dollars.

FIG. 4 illustrates another alternative embodiment of a system 401 for accessing a redundant memory array and reducing access latencies. System 401 includes memory controller hub, MCH 410 and bus master 411. System 401 includes mirrored memory or RAID memory comprising DIMM 420 where mirroring is done between partitions of separate RAM ICs within DIMM 420. DIMM 420 includes AMB 429 and RAM ICs 421-428.

A memory access request for a memory address corresponding to the mirrored memory locations 402 and 403 is received by MCH 410 from bus master 411 and transmitted to DIMM 420. A determination may be made in AMB 429 if one of the banks (or rows) of memory having the memory locations 402 or the memory locations 403 is active. Embodiments of AMB 429 are operatively coupled with RAM ICs 421-428 to transmit memory access requests as split transactions to redundant mirrored RAM ICs within DIMM 420 or alternatively to transmit a memory access request only to redundant mirrored RAM IC memory partitions within DIMM 420 having the memory location 402 or the memory location 403 in an active memory bank (or row) to avoid an activation delay.

It will be appreciated that significant improvements in access latencies may be realized for memory access requests to the redundant memory array of system 401 through utilizing programmable features of AMB 429 and/or MCH 410. It will also be appreciated that a mirroring failure in system 401 would not require disabling of the entire DIMM, but rather only the partition that failed could be disabled. Thus through programmable features of AMB 429 and/or of MCH 410, reductions in costs, improved fault tolerance and improved access latencies may be realized for memory access requests to the redundant memory array of system 401.

The above description is intended to illustrate preferred embodiments of the present invention. From the discussion above it should also be apparent that especially in such an area of technology, where growth is fast and further advancements are not easily foreseen, the invention be modified in arrangement and detail by those skilled in the art without departing from the principles of the present invention within the scope of the accompanying claims and their equivalents.

What is claimed is:

1. A method for reducing memory access latencies in a mirrored memory, the method comprising:
receiving a memory access request for a memory address;
determining if a memory portion of a plurality of memory mirrors for the memory address is active;
if the memory portion is determined to be active, then servicing the memory access request using that memory portion to avoid an activation delay; otherwise
initiating activation of the memory portion to service the memory access request.

2. The method of claim 1 wherein the memory access request is a read request.

3. The method of claim 1 wherein each of the plurality of memory mirrors is on a different dual in-line memory module.

4. The method of claim 3 wherein determining if the memory is active is performed by a memory controller hub.

5. An article of manufacture comprising
a machine-accessible tangible medium including data that, when accessed by a machine, cause the machine to perform the method of claim 4.

6. The method of claim 1 wherein the plurality of memory mirrors are on a single dual in-line memory module.

7. The method of claim 6 wherein determining if the memory is active is performed by an advanced memory buffer on the single dual in-line memory module.

8. An article of manufacture comprising
a machine-accessible tangible medium including data that, when accessed by a machine, cause the machine to perform the method of claim 7.

9. An article of manufacture comprising:
a machine-accessible tangible medium including executable instructions that, when accessed by a first machine, causes the first machine to:
receive a memory access request for a memory address;
determine if a memory portion of a plurality of memory mirrors for the memory address is active;
when the memory portion is determined to be active, then service the memory access request using the active memory portion to avoid an activation delay; otherwise
initiating activation of the memory portion to service the memory access request.

10. The article of manufacture of claim 9 wherein the memory access request is a read request.

11. The article of manufacture of claim 10 wherein the first machine is a memory controller.

12. The article of manufacture of claim 11 wherein each of the plurality of memory mirrors is on a different dual in-line memory module.

13. The article of manufacture of claim 10 wherein the first machine is an advanced memory buffer on a single dual in-line memory module.

14. The article of manufacture of claim 13 wherein the plurality of memory mirrors are on a single dual in-line memory module.

15. A dual in-line memory module (DIMM) apparatus comprising:
a plurality of random access memory (RAM) integrated circuits (ICs) configurable for data mirroring between partitions of separate RAM ICs within the DIMM;
a programmable logic circuit, responsive to receiving a memory access request for a memory address corresponding to a plurality of mirrored memory locations in different partitions of the RAM ICs within the DIMM, to determine if a memory portion holding one of the plurality of mirrored memory locations is active;
if the memory portion is determined to be active, said programmable logic circuit to transmit the memory access request only to the active memory portion to avoid an activation delay;
otherwise said programmable logic circuit to initiate activation of the memory portion to service the memory access request.

16. The apparatus of claim 15 wherein the memory access request is a read request.

17. The apparatus of claim 16 wherein the programmable logic circuit is part of an advanced memory buffer for the DIMM.

18. A computing system comprising:
a bus master to initiate a memory access request;
a plurality of random access memory (RAM) integrated circuits (ICs) configurable for data mirroring between partitions of separate RAM ICs; and
a machine-accessible tangible medium including data that, when accessed by a first machine, causes the first machine to:
receiving a memory access request for a memory address corresponding to a plurality of mirrored memory locations in different partitions of the RAM ICs;
determine if a memory portion holding one of the plurality of mirrored memory locations is active;
if the memory portion is determined to be active, transmit the memory access request only to the active memory portion to avoid an activation delay; otherwise
initiate activation of the memory portion to service the memory access request.

19. The computing system of claim 18 wherein the memory access request is a read request.

20. The computing system of claim 18 wherein the first machine is a memory controller.

21. The computing system of claim 20 wherein the partitions of separate RAM ICs are configurable for data mirroring only between different dual in-line memory modules.

22. The computing system of claim 18 wherein the partitions of separate RAM ICs are configurable for data mirroring on a single dual in-line memory module.

23. The computing system of claim 22 wherein the first machine is an advanced memory buffer on the single dual in-line memory module.
